(19) United States
(12) Patent Application Publication
(10) Pub. No.: US 2002/0007346 A1
(43) Pub. Date: Jan. 17, 2002

(54) Method and apparatus for establishing global trust bridge for multiple trust authorities

(76) Inventors: Xin Qiu, San Diego, CA (US); David Reader, Encinitas, CA (US); Benoit Lheureux, San Diego, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/875,690

(22) Filed: Jun. 6, 2001

Related U.S. Application Data
(60) Provisional application No. 60/209,659, filed on Jun. 6, 2000.
(60) Provisional application No. 60/209,697, filed on Jun. 7, 2000.
(60) Provisional application No. 60/209,658, filed on Jun. 6, 2000.

(51) Int. Cl. G06F 17/60

(52) U.S. Cl. 705/50

(57) ABSTRACT

A system is provided for authenticating messages between at least two parties that do not share a common trust provider, such as a certificate authority. Thus, a third party can be used to span trust between the parties by providing a common shared trust.

### CROSS-REFERENCES TO RELATED APPLICATIONS

This application claims the benefit of the following U.S. patent applications: Ser. No. 60/209,659, filed Jun. 6, 2000 entitled “METHOD AND APPARATUS FOR ESTABLISHING GLOBAL TRUST BRIDGE FOR MULTIPLE TRUST AUTHORITIES”; Ser. No. 60/209,697, filed Jun. 7, 2000 entitled “SECURE USER-LEVEL ETRUST DISTRIBUTION MODEL”; and Ser. No. 60/209,658, filed Jun. 6, 2000 entitled “INFRASTRUCTURE OF GLOBAL TRUSTED BRIDGE FOR CERTIFICATE VALIDATION”, all of which are hereby incorporated by reference for all purposes.

The present invention is related to cryptography and, in particular, to providing shared trust in a cryptographic network, such as distributing financial responsibility and/or liability between different parties for different cryptographic aspects involved in a transaction.

### BACKGROUND

In communicating, e.g., over the Internet, there will be instances where strangers or trading partners wish to transact business with one another. This is particularly true in the area of business to business relationships on a global scale. The market for business to business transactions has for the most part developed regionally. Thus, businesses in Singapore, for example, conduct business via the Internet with other businesses in Singapore. Similarly, businesses in other countries conduct trade with other businesses in the same country. Part of the reason for this is that certificate authorities have developed in a regional way. Thus, one certificate authority (CA) will often issue certificates, such as X.509 certificates, to businesses all in one country, while a second certificate authority will issue X.509 certificates, for example, to businesses in a different country. Thus, the businesses that are all certified by the same CA can easily verify the identity of one of their on-line trading partners because they are both certified by the same CA. However, when two businesses (or entities) who have no common CA wish to do business (or conduct any sort of verifiable communication), a problem occurs. There is no mechanism to allow the businesses to easily establish trust between them so that their individual identities can be verified.

One proposal which is outlined in the Handbook of Applied Cryptography, by Menezes et al., CRC Press LLC, 1997 on pages 570-577 is to cross certify CA's. While this is a logical approach when the entities are related, in a commercial setting it is not practical. For example, it would be like asking two credit card companies to cooperate with one another—it simply is not a willing exchange by competitors. Furthermore, it does not allow a third party to serve as an interface between the two CAs. Thus, there is a need for a way to facilitate the transaction of business between parties who have no common CA.

One of the drawbacks to global trading is the lack of infrastructure for providing various forms of trust including authentication, non-repudiation and financial responsibility, e.g., liability, for the authentication of different parties, for example trading partners, from different certificate authorities who are involved in financial transactions. Namely, a first certificate authority is responsible for authenticating a first party under the first CA's domain. Similarly, a second certificate authority is responsible for authenticating the identity of a second party in the transaction, such as a buyer in a buy/sell agreement, in the second CA's domain. However, due to the fact that the certificate authorities are distributed throughout the world, there is no existing global authority to provide a global trust or to assume financial responsibility for a transaction which crosses the domains of the two certificate authorities.

### SUMMARY

One embodiment of the invention provides a system for providing financial responsibility, e.g., liability, for a transaction, e.g., a business transaction such as a Purchase Order, between a first trader or first party which is certified by a first certificate authority and a second trader or second party which is certified by a second certificate authority. Because the first and second traders use no common certificate authority for establishing trust, the system provides for receiving at a trust bridge a certificate for the first trader issued by the first certificate authority. Also, the system provides for receiving at the trust bridge a certificate for the second trader issued by the second certificate authority. Furthermore, validation of the first trader is provided to the second trader by the trust bridge; and, financial responsibility is provided for incorrect validation of the first trader to the second trader by the trust bridge.

In another embodiment of the invention a system is provided for establishing authentication between at least a first party and a second party, e.g., traders. The first party is certified with a first certificate authority as well as certified with a second certificate authority different from the first certificate authority. A third party, e.g., the trust bridge entity, is certified with a first certificate authority as well as certified with the second certificate authority. A message is conveyed from the first party to the third party such that the third party can authenticate the message as being from the first party. The message is conveyed from the third party to the second party such that the second party can authenticate that the message came from the third party. The first certificate authority is allowed to provide financial responsibility, e.g., liability, for any incorrect validation of the first party while the third party provides financial responsibility to the second party for incorrect validation of a certificate issued by the first party.

In yet another embodiment of the invention, a system is provided which provides non-repudiation of a communication from a first party or trader certified by a first certificate authority to a second party or trader certified by a second certificate authority. The communication can be for a transaction for a product, i.e., goods or services, and the first party and second party have no common certificate authority. A trust bridge receives certification from a first certificate authority as well as a certification from a second certificate authority. The trust bridge receives from the first party a communication bound for the second party via the trust bridge. Non-repudiation of the communication from the first party to the second party is established with the trust bridge.

In one embodiment of the invention a certificate revocation list can be generated to serve as a master certificate revocation list for multiple certificate authorities. For example, certificate revocation lists can be pulled from or received from various certificate authorities and combined to form a master certificate revocation list. This certificate revocation list can then be distributed. For example, the master certificate revocation list can be distributed to hubs which use the services of the trust bridge.

In another embodiment of the invention, a trust bridge is provided to facilitate a trust relationship between two parties that do not utilize a common certificate authority.

### BRIEF DESCRIPTION OF THE DRAWINGS

FIG. 1 illustrates an embodiment of the invention of providing a trust bridge between multiple trading hubs.

FIG. 2 illustrates an embodiment of the invention for providing a trust bridge for providing infrastructure for trading across multiple certificate authority domains.

FIG. 3 illustrates an embodiment of the invention having multiple certificate authorities, multiple hubs, and multiple traders.

FIG. 4 illustrates an embodiment of the invention as a subset of FIG. 3.

FIG. 5 illustrates an embodiment of the invention as a subset of FIG. 3.

FIG. 6 illustrates an embodiment of the invention as a subset of FIG. 3.

FIG. 7 illustrates an embodiment of the invention as a subset of FIG. 3.

FIG. 8 illustrates an example of a certificate granted by a certificate authority under one possible standard.

FIG. 9 illustrates a flowchart for one embodiment of the invention for providing a trust bridge to facilitate trading.

FIG. 10 illustrates a flowchart for one embodiment of the invention to facilitate providing shared trust by a third party in a cross-domain transaction.

FIGS. 11a and 11b illustrate a flowchart for one embodiment of the invention for establishing non-repudiation of a transaction.

FIG. 12 illustrates a time line for an embodiment of the invention that permits division of financial responsibility for a certificate revocation list.

FIG. 13 illustrates an example of a processing-system based implementation applicable to the trust bridge in accordance with an embodiment of the invention.

FIG. 14 illustrates an example of generating a signature by a trading partner under one embodiment of the invention.

### DESCRIPTION

In the following detailed description of the embodiments, reference is made to the accompanying drawings which form a part hereof, and in which are shown by way of illustration specific embodiments of the invention. These embodiments are described in sufficient detail to enable those skilled in the art to practice the invention and it is to be understood that other embodiments may be utilized and that structural, logical, and network changes may be made without departing from the spirit and scope of the present invention. The following description is therefore not to be taken in a limiting sense.

In recent years networked trading groups have developed that are centralized in their respective countries or trading territories. These trading groups thus operate under a hierarchy of a primary certificate authority for each respective trading group. As a result of this, each certificate authority serves as the primary source of trust for transactions between the various end users, e.g., traders, of the trading group. However, a limiting aspect of the present system is that very little cross-domain trading, e.g., trading by traders who use no common CA, can readily take place. This is due to the fact that it is difficult to authenticate the identity of traders who are not certified by a common certificate authority. Furthermore, no infrastructure existed in the past for providing trust for trading between trading partners with certificates issued by different CAs. Therefore, a buyer who was certified under a first certificate authority had no way of trusting, e.g., authenticating the identity of a seller or trusting the integrity of a message, in a domain covered by a second certificate authority. Thus, the various trading clusters have originated; but, the members of these trading clusters find it difficult to trade outside of their own individual trading cluster.

One embodiment of the invention provides a solution to this problem by distributing or assuming financial responsibility, e.g., liability, for transactions taking place between members of different trading clusters. Therefore, liability for a transaction between members of different trading clusters can be distributed between the certificate authorities for each trading cluster and the new entity which links the trading clusters for purposes of authenticating the identity of the participating parties.

Trust Bridge

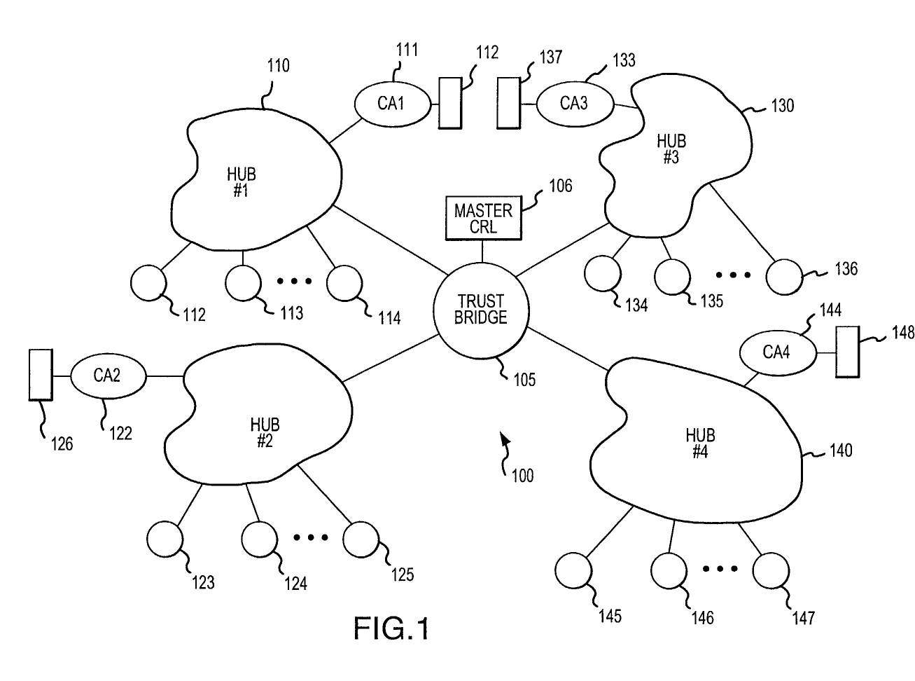

FIG. 1 illustrates a system 100 for accomplishing an embodiment of the invention. In FIG. 1 a trust bridge 105 serves as an interface or bridge between different trading groups or trading clusters noted as Hub no. 1, 110, Hub no. 2, 120, Hub no. 3, 130 and, Hub no. 4, 140. As can be seen in FIG. 1, each hub has end users, e.g., traders, and each hub and the end users associated with each hub are certified by a different certificate authority. For example, Hub no. 1 has end users 112, 113, and 114; Hub no. 2 has end users 123, 124, and 125; Hub no. 3 has end users 134, 135 and 136; and, Hub no. 4 has end users 145, 146, and 147. While three end users are shown for each hub in FIG. 1, a hub could have any different number of actual end users.

In FIG. 1, each hub is shown coupled to a certificate authority. Thus Hub no. 1 is coupled to CA 1 designated 111, while Hub no. 2 is coupled to CA 2 designated 122, and Hub no. 3 is shown coupled to CA 3 designated 133; while Hub no. 4 is shown coupled to CA 4 designated 144. Thus, each CA is operable to provide a certificate to the end users in each trading hub.

FIG. 1 also shows a certificate revocation list (CRL) coupled to each of the certificate authorities. Namely, CRL 112 is coupled to CA 1, while CRL 126 is coupled to CA 2, and CRL 137 is coupled to CA 3, and finally CRL 148 is coupled to CA 4. Furthermore, the trust bridge is shown coupled to a master CRL 106.

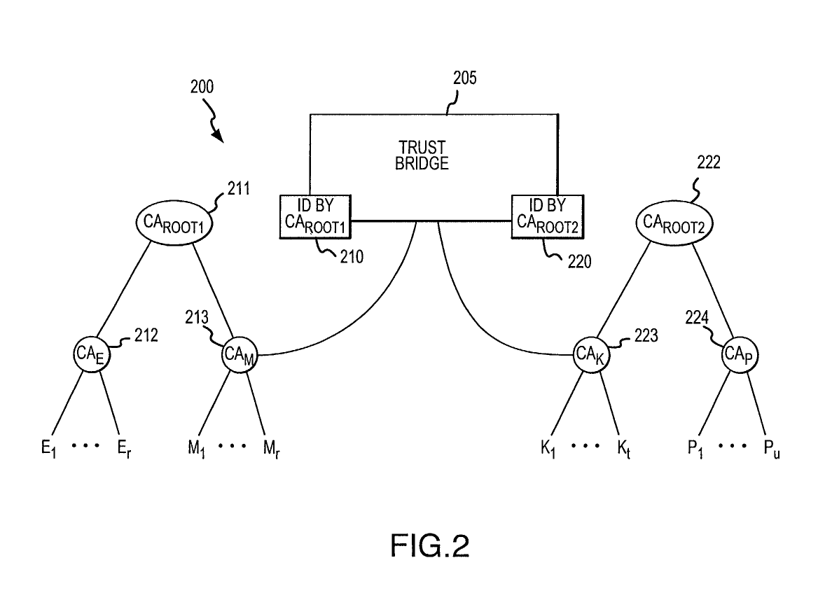

Thus, the system 100 shown in FIG. 1 provides a system for coupling end users operating in different domains so as to facilitate a transaction between those end users. The trust bridge can be certified by each of the respective certificate authorities. Thus, when transactions are required by entities certified by different certificate authorities, a trust can be established through the trust bridge , rather than requiring the certificate authorities to cross certify one another. This can be accomplished because the trust bridge has established a trust with each of the respective certificate authorities. Therefore, the trust bridge serves as an entity that facilitates a trusted relationship between at least two parties that do not use a common CA, without requiring the two parties to cross-certify one another. Thus, for example, the trust bridge can authenticate the identity of an end user from one trading cluster to an end-user in a different trading cluster. Thus a spoke arrangement can be accomplished by using the trust bridge entity as a master hub or trust bridge. Alternative hub arrangements are illustrated in FIGS. 2, 3, 4, 5, 6, and 7.

Trust Chaining

FIG. 2 shows a basic system 200 for establishing a trust bridge between the parties. In FIG. 2, a first hub is shown having E₁-Eᵣ certified under CA_{E} 212 and M₁-Mᵣ certified under CAₘ 213. CA_{E} and CAₘ are certified under CAᵣₒₒₜ₁ 211. A second hub exists on the opposing side of a trust bridge 205. Namely, end users K₁-K_{T} are certified under CAₖ 223 and end users P₁-Pᵤ are certified under CAₚ 224. CAₖ and CAₚ are certified under CAᵣₒₒₜ₂ 222. The trust bridge 205 contains an ID 210 by CAᵣₒₒₜ₁ and an ID 220 by CAᵣₒₒₜ₂. Thus, the trust bridge has been certified by both CAᵣₒₒₜ₁ and CAᵣₒₒₜ₂. Consequently, when an end user which has been certified by a CA under the umbrella of CAᵣₒₒₜ₁ wishes to conduct an exchange of information with an end user who has been certified by a CA under the umbrella of CAᵣₒₒₜ₂, the identity of each of those respective end users can be verified because the trust bridge contains certificates by CAᵣₒₒₜ₁ and CAᵣₒₒₜ₂. Thus, the trust bridge will be able to verify signatures made under such roots. As can be seen, it is not necessary that CAᵣₒₒₜ₁ and CAᵣₒₒₜ₂ be cross-certified; rather, supplying a trust bridge which has been certified by both CA's allows the identities of both trading parties to be verified.

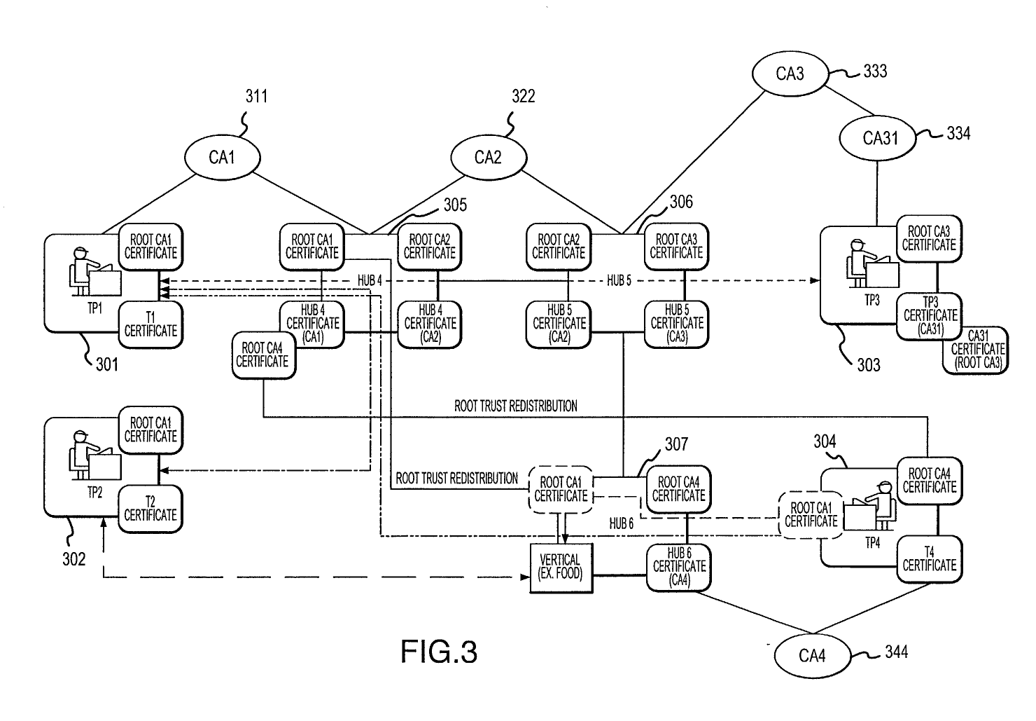

FIG. 3 shows another example. Trading partner (TP) 1, TP2, TP3, and TP4 are shown in FIG. 3. TP1 301 and TP2 302 are each certified by CA1 311. Thus, they contain a Root CA1 certificate. Furthermore, TP1 contains a T1 certificate (a certificate issued to TP1 by CA1), while TP2 contains a T2 certificate (a certificate issued to TP2 by CA1). TP3 303 is certified by CA31 334; however, CA31 is certified under CA3 333. Thus, TP3 has a TP3 certificate issued by CA31 and a CA31 certificate which is issued by CA3. Furthermore, it has a Root CA3 certificate. TP4 304 is certified under CA4 344. Thus, it has a T4 certificate and a root CA4 certificate. TP4 also has a Root CA1 certificate which it obtains by redistribution of root trust that allows trading to take place under one embodiment of the invention.

Three trading clusters are shown and labeled as “Hub 4” 305, “Hub 5” 306 and “Hub 6” 307. Hub 4 is certified by CA1 and CA2 322 as demonstrated by the lines from these respective CA's. Thus, Hub 4 has a Root CA1 certificate and a Hub 2 certificate from CA₁. It also has a Root CA₂ certificate and a Hub 2 certificate from CA₂. Finally, it has a Root CA4 certificate which it receives as a result of root trust redistribution which is the process of one party transferring its public certificate to another party for the purpose of allowing the receiving partner to authenticate certificates from the originator. Similarly, Hub 5 is certified by CA₂ and CA₃. Thus, it has a Root CA₂ certificate and a Hub 5 certificate from CA₂. It also has a Root CA₃ certificate and a Hub 5 certificate from CA₃. Finally, Hub 6 is certified by CA₄. Thus, it has a Root CA₄ certificate and a Hub 6 certificate from CA₄. It also receives a Root CA1 certificate through root trust redistribution.

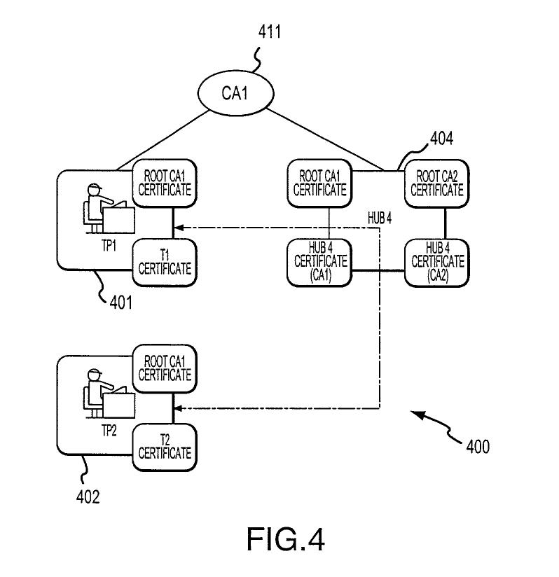

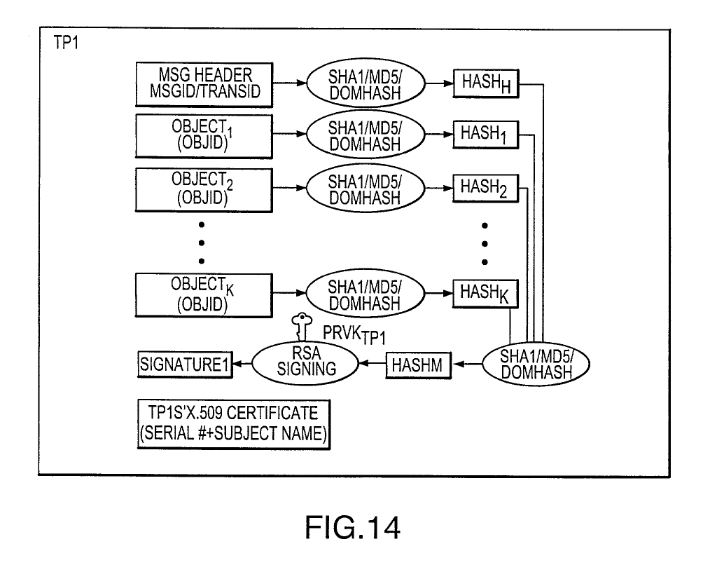

FIG. 4 shows a system 400 and an example of a transaction between members of the Hub 4 404, namely TP1 401 and TP2 402. As shown in the block explaining TP₁'s actions in FIG. 14, the message is signed (signature 1) using TP1's private key and X.509 certificate. The message is then sent to Hub 4 which can then verify the signature 1 to verify that the message is from TP1. The Root CA1 certificate can be used to verify the TP1's certificate. A second signature can be added by Hub 4 to show that it verified the signature 1. However, since both TP1 and TP2 have Root CA1 certificates, the message could simply be routed to TP2 and TP2 could perform the verification step itself. If signature 2 is added, however, then TP2 would perform the procedure to verify Hub 4's signature 2. Thus, it would check the Certificate Revocation List distributed by CA1 411 to ensure that Hub 4's certificate was not revoked. It could use the Root CA1 public key to verify the Hub 4 certificate and use the Hub 4 public key extracted from the certificate to verify signature 2.

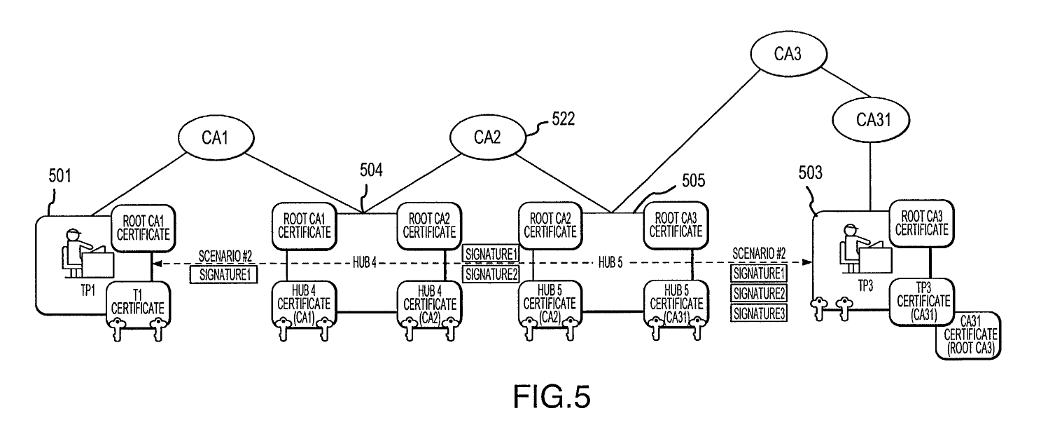

FIG. 5 shows a different scenario in which shared trust is distributed across more than one hub. Thus, when TP1 501 wishes to transact with TP3 503, Hub 4 504 and Hub 5 505 can be used to chain the transaction, because along every link there is a shared trust that allows the transaction to be verified. Thus TP1 can convey a message to Hub 4 with signature 1. An example of generating this message and signature can be seen in FIG. 14. Then, Hub 4 can verify the signature by following, for example, the following procedure:

1) check CRL to ensure TP1's certificate is not revoked;

2) use RootCA1 (public key) to verify TP1's certificate;

z3) use TP1's public key extracted from certificate to verity signature 1;

4) generate signature 2 using Hub 4's private key 2;

5) attached Hub 4's certificate to the message; and

6) send to Hub 5.

Because Hub 4 is also certified by CA2 522 and because Hub 5 is certified by CA2, the common trust allows the message to be linked from Hub 4 to Hub 5. Thus, a signature 2 is added by Hub 4 and verified by Hub 5. Hub 5 then can add its signature, “signature 3”, in FIG. 5 to verify the authenticity of the message. TP3 can then verify the signature of Hub 5 to determine that the message is authentic. Essentially, Hub 4 and Hub 5 are links that each have a common trust that when combined comprise trusts for the two trading entities. Furthermore, even more links in this chain could be added, such that TP1 and TP3 are eventually linked together.

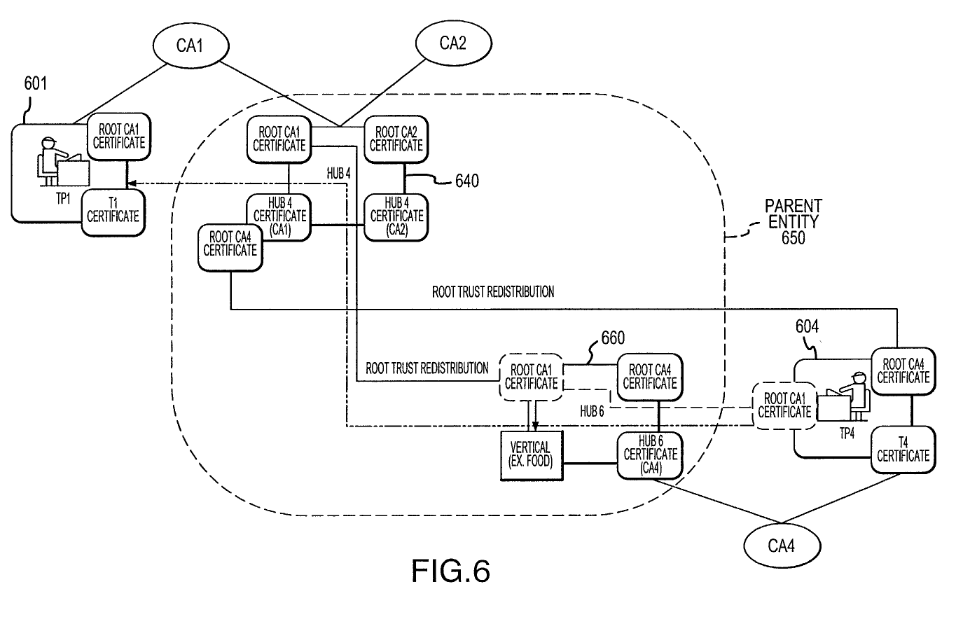

FIG. 6 demonstrates an embodiment in which trust is distributed from one hub to another hub. In FIG. 6, TP1 601 is transacting with TP4 604 through Hub 4 640 and Hub 6 660. However, for purposes of this example, Hub 4 and Hub 6 are considered to be components of a parent entity. Thus, Hub 4 and Hub 6 have preexisting knowledge of one another and know that they can trust one another, which means that it is not essential (although still shown in the figure) that the two hubs exchange root certificates via root trust distribution. Thus, when Hub 4 obtains the Root CA1 certificate, it is as if Hub 4 obtained the Root CA1 Certificate for the parent entity 650. Thus, this Root CA1 certificate can be distributed across the parent entity from one hub to other hubs and end-users. Consequently, in the example shown in FIG. 6, the Root CA1 certificate is redistributed to Hub 6. Thus, a chain is established between TP1 and TP4, namely TP1 to Hub 4 to Hub 6 to TP4. In each link of the chain, both parties at the end of each link share a common certificate of authority that allows communications to be verified.

FIG. 6 also demonstrates that Root CA1 certificate can be distributed to TP4. Thus, TP4 could interface directly with Hub 4, since they both share a common Root CA certificate, namely Root CA1 certificate. In fact, TP1 and TP4 could connect directly, since they both share a common Root CA1 certificate after the Root CA1 certificate is distributed to TP4. The distribution of the Root CA4 certificate to Hub 4 would also allow a direct connection between TP4 and Hub 4.

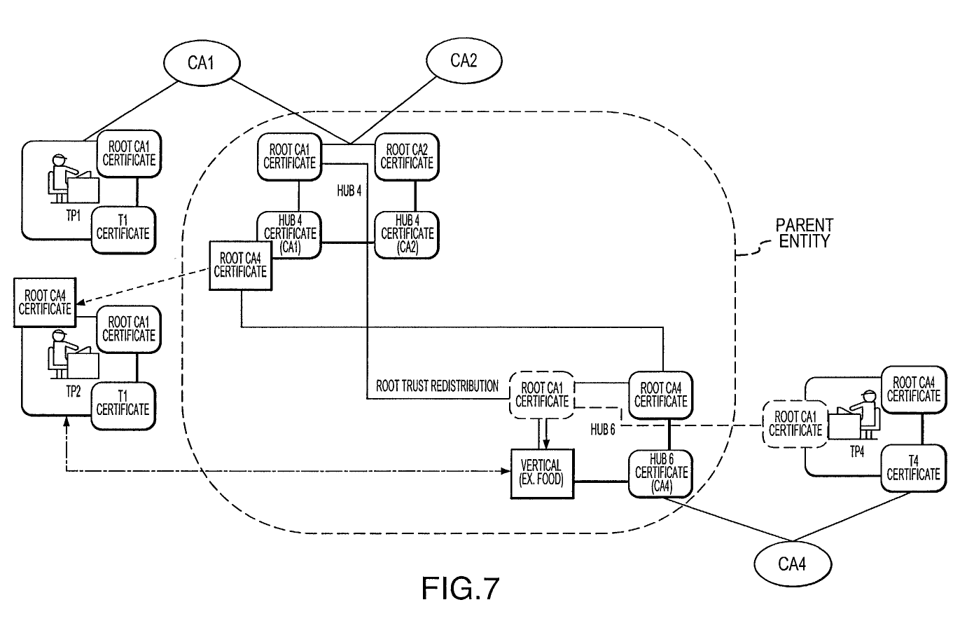

FIG. 7 demonstrates another embodiment in which a direct connection can be facilitated between two unaffiliated parties. In FIG. 7, a member of Hub 6 is shown as a trading group that trades in food labeled as “Vertical (ex. Food)” in FIG. 7. It wants to be able to trade directly with another party, e.g., TP2, who belongs to Hub 4. However, it doesn't want to go through the chain of Hub 6 and Hub 4. Rather, it would prefer to establish a direct relationship with TP2. This can be accomplished by distributing the Root CA4 certificate from Hub 6 to Hub 4, as they are both members of a parent entity which verifies transactions between Hub 6 and Hub 4, followed by distributing the Root CA4 certificate from Hub 4 to TP2, as both are certified by CA1. Then, since TP2 has the Root CA4 certificate and the other party labeled “Vertical” has a Root CA1 certificate, a direct trading relationship can be established between TP2 and Vertical. Thus, the ability to flow the root certificates through a third party, e.g., the parent entity which comprises Hub 4 and Hub 6, allows a direct line of authenticated communication to be established between two parties.

Certificate Authorities

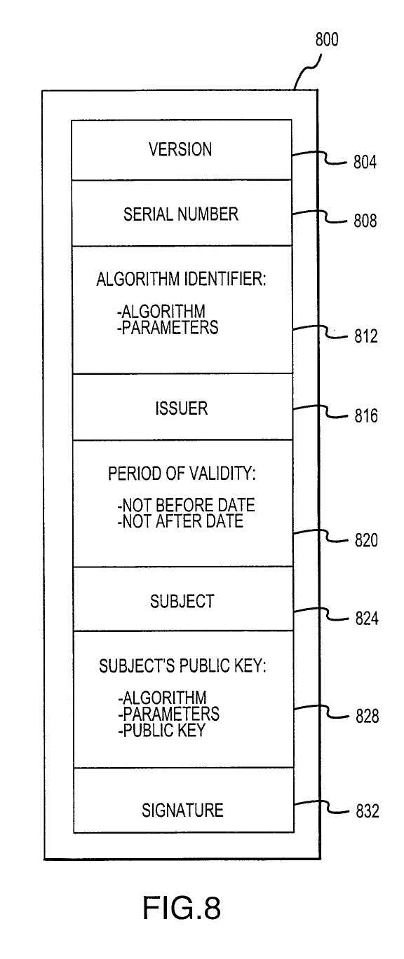

One particular standard that has evolved is the X.509 standard and its structure for public key certificates. Thus, it can serve as an exemplary standard for purposes of this description. Under this standard, each user has a distinct name. A trusted certificate authority assigns a unique name to each user and issues a signed certificate containing their name and the user's public key. For example, one exemplary certificate is shown in FIG. 8 as X.509 certificate 800. In this certificate, a version field 804 is provided to identify the certificate format. Furthermore, a serial number 808 is provided which is unique within the particular certificate authority issuing the certificate. The algorithm identifier field 812 is used to sign the certificate, together with any necessary parameters. The issuer field 816 is used to designate the name of the certifying authority. The period of validity field 820 is shown using a pair of dates. The certificate can be valid during the time period between these two dates. The subject field 824 can be used to indicate the name of the user. The subject's public key field 828 can be used to hold information such as the algorithm name, e.g., RSA, any necessary parameters, and the public key. The signature field 832 is used to provide the certificate authority's digital signature. The X.509 certificates, for example, can be stored on databases throughout a network, such as the internet. Users can send them to each other or receive them from one another. When a certificate expires it can be removed from any public directories or retained should a dispute arise later.

Certificate Revocation List

Certificates can also be revoked by a certificate authority. For example, a need for this can arise when the digital signature of an end user is compromised or the certificate authority's key has been compromised. Similarly, the certificate authority may simply decide that it no longer wants to certify the end user. Each certificate authority maintains a list of all revoked but unexpired certificates. Therefore, when an end user receives a new certificate from a party, the end user checks to see whether that particular certificate has been revoked. A database of revoked certificates on the network can be checked or alternatively a cached list of revoked certificates can be checked locally. Each certificate authority provides a list of revoked certificates as its own “certificate revocation list” (CRL). In one embodiment of the invention, a master certificate revocation list is compiled so as to provide a master set of revoked certificates for all certificate authorities trading under the umbrella of the trust bridge.

Distributed Trust

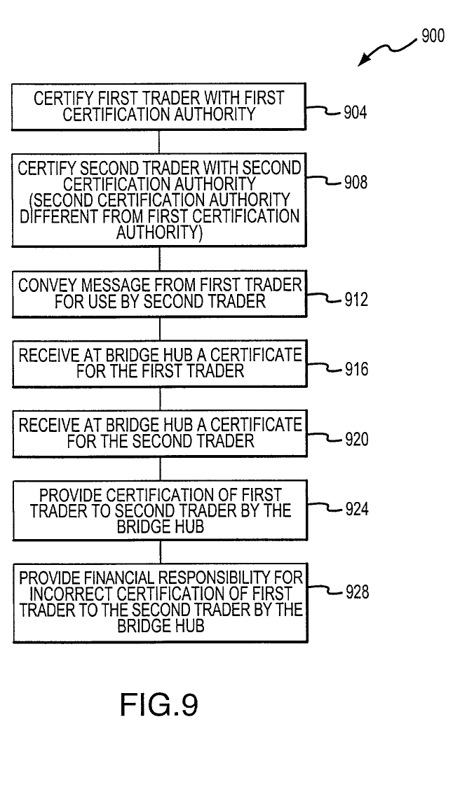

FIGS. 9, 10 and 11 illustrate different embodiments for distributing trust, e.g. financial liability or authentication responsibility in a cross-domain transaction operating under multiple certificate authorities. In one embodiment of the invention a system is provided that distributes liability between a certificate authority which authenticates the identity of an end user to a trust bridge while a second level of liability is extended by the trust bridge to at least a second end user participating in the transaction with the first end user.

In FIG. 9 an embodiment of the invention for providing trust and financial responsibility for a transaction between a first trader and a second trader is illustrated. In flowchart 900, a first trader is certified by a first certificate authority as shown in block 904. Furthermore, the second trader participating in a transaction is certified with a second certificate authority as shown in block 908. It should be understood that the first trader and the second trader are not certified under a common certificate authority. A message is conveyed from the first trader for use by the second trader as shown in block 912. For example, such a message might be an offer for purchasing an item from the second trader or an acceptance of an offer from the second trader. In block 916, the trust bridge receives a certificate authenticating the first trader. Thus the trust bridge is able to authenticate the identity of the first trader by the certificate.

A trust bridge practice statement can be provided by a trust bridge to define financial responsibility limits to end users of the trust bridge which authenticates end users. Such a trust bridge practice statement is similar to a certification practice statement issued by certificate authorities. Such certification practice statements can be used to outline the limits of responsibility of certificate authorities to their end users.

Thus, a two-tiered level of liability can be established through the use of the trust bridge. Namely, the certificate authority can assume responsibility for the authentication of the end user to the trust bridge, while the trust bridge can assume responsibility for the authentication to a second trader. Thus, the certificate authority operates within its own domain while the trust bridge extends trust for the actions of an end user to a second domain.

Similarly, the trust bridge can also or alternatively assume responsibility for obtaining a certificate revocation list for a certificate authority and validating the certificate of an end-users. Thus, the trust bridge may also or alternatively provide financial responsibility if the certificate of the first trader has been revoked. The extent and combination of this liability can be defined in a variety of pre-defined ways as desired by the trust bridge. Thus, these pre-defined terms can be set forth in a trust bridge practice statement the terms of which traders using the trust bridge agree to.

At block 920 the trust bridge receives a certificate for the second trader. Such a certificate can be provided by the trust bridge to the first trader when a response to the message from the first trader is returned by the second trader. In block 924 validation of the first trader is provided by the trust bridge to the second trader so as to authenticate the identity of the first trader to the second trader. Thus, as shown in block 928, financial responsibility for incorrect validation of the first trader can be provided to the second trader by the trust bridge. Such financial responsibility as mentioned above can take a variety of forms. For example, the financial responsibility could be for the validity of the certificate of the first trader. Namely, liability would attach if the certificate had been revoked and the trust bridge failed to recognize the revocation under the terms of its trust bridge practice statement. Alternatively, financial responsibility could attach if the authentication of the first trader was incorrect. Thus, liability could attach to the trust bridge's failure to correctly authenticate the first trader's identity. Similarly, in communications directed from the second trader to the first trader financial responsibility could be provided for incorrect validation of the second trader to the first trader. As noted in the example above, a first certificate authority could provide financial responsibility for incorrect validation of the first trader while a second certificate authority could provide financial responsibility for incorrect validation of the second trader.

A certificate revocation list can be obtained from the first certificate authority and from the second certificate authority so as to produce a master certificate revocation list. This master certificate revocation list can be published to participants of the trust bridge. Thus, the trust bridge can act to validate the certificates of the various end users, each with their own different certificate authorities. A trust bridge practice statement can be provided by the trust bridge so as to define the terms of financial responsibility, e.g., liability, for inaccurate validations.

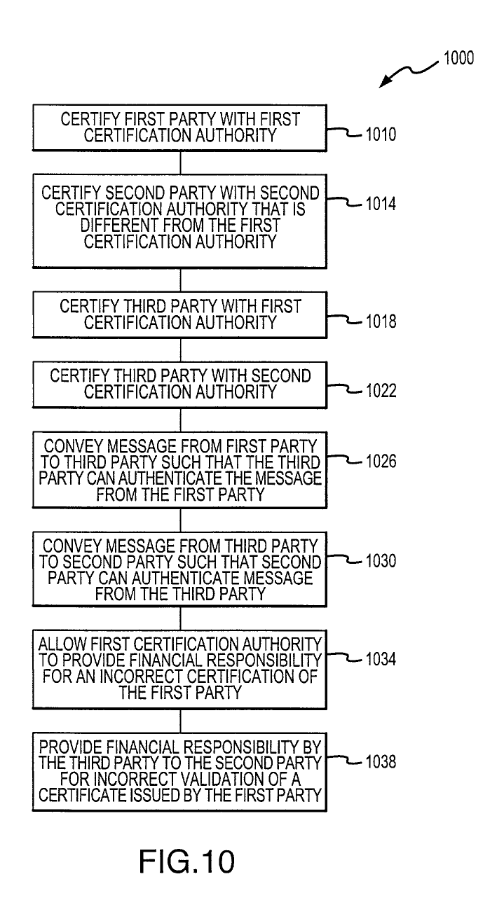

FIG. 10 illustrates another embodiment of the invention. In block 1010 of FIG. 10, the first party is certified with a first certificate authority. In block 1014, a second party is certified with a second certificate authority. Both the first party and the second party do not have a common certification authority. Thus, they are unable to authenticate the identity of one another within their own respective certificate authorities. In block 1018, a third party is certified with the first certificate authority. In block 1022, the third party is also certified with the second certificate authority. A message is conveyed from the first party to the third party so that the third party can authenticate the identity of the first party and determine that the message came from the first party in block 1026 of flowchart 1000. The message is conveyed from the third party to the second party so that the second party can authenticate the message from the third party in block 1030. In block 1034 a first certificate authority is allowed to provide financial responsibility for an incorrect certification of the first party. Finally, in block 1038, the third party can provide financial responsibility to the second party for incorrect validation of a certificate issued by the first party. To accomplish this, as noted above, a master certificate revocation list can be compiled by obtaining certificate revocation lists from each certificate authority. Furthermore, a trust bridge practice statement defining the financial responsibility limits of the third party can be supplied to each end user which utilizes the third party such as an end user utilizing a trust bridge.

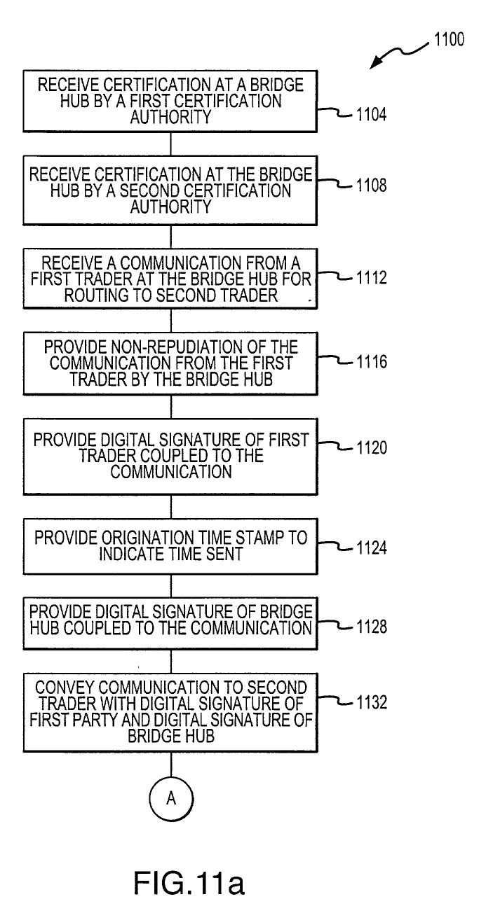

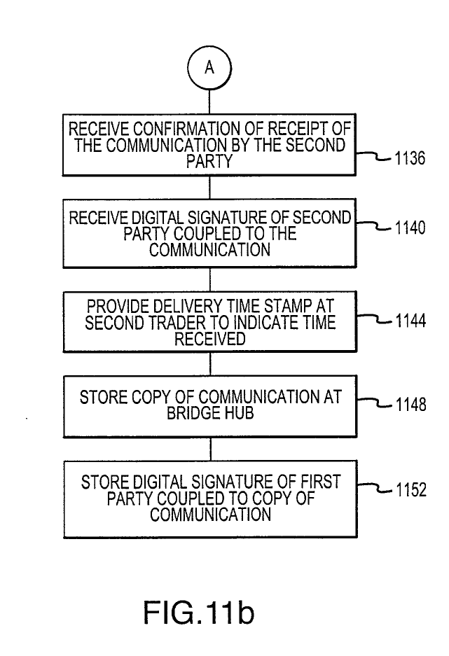

FIGS. 11a and 11b illustrate a flowchart 1100 for another embodiment of the invention. In block 1104 a trust bridge receives a certification by a first certificate authority. In block 1108 the trust bridge receives certification from a second certificate authority. In block 1112 the trust bridge receives a communication from a first trader for routing to a second trader. The first trader and second trader are certified under the first and second certificate authorities, respectively. In block 1116 the trust bridge provides a non-repudiation service for the communication from the first trader to the trust bridge.

Non-repudiation of a message communicated between traders allows each trader to further their goals of establishing commercial relationships with others in different domains. Thus, because traders certified under a common certificate authority can easily verify the identity of one another, they can easily establish non-repudiation of messages conveyed to one another. Thus, the formulation of contracts and binding agreements is facilitated. However, in agreements across domains having no common root certificate authority, trading entities are less likely to enter into contracts unless they can confirm that the parties with whom they are contracting will not repudiate, e.g., deny having sent the messages, the messages received. Thus, they are hesitant to establish relationships with parties not certified in their own CA domain. The present embodiment of the invention facilitates commercial transactions across different domains by providing a bridge that can authenticate the identity of the various trading partners and provide a non-repudiation service for transactions accomplished through the trust bridge.

A variety of evidentiary systems can be utilized to provide the non-repudiation service. For example, as shown in block 1120 a digital signature of a first trader can be coupled to the communication sent to the trust bridge intended for the second trader. This digital signature of the first trader in conjunction with the communication can be stored and indefinitely archived for later retrieval by the trust bridge so as to establish a non-repudiable event. Similarly, in block 1124 an origination time stamp can be provided so as to evidence the time that the communication was sent from the first trader. Such times can be important in a commercial transaction as one of ordinary skill in the art would readily appreciate. In block 1128 a digital signature of the trust bridge can also be coupled to the communication and conveyed to the second trader. Thus, a combination of digital signatures can be accomplished so as to further provide non-repudiable evidence of a communication for a transaction. In block 1132 the communication can be conveyed to the second trader with the digital signature of the first party and the digital signature of the trust bridge. Furthermore, in block 1136, the communication can then be received by the second party and a confirmation message generated and communicated either to the trust bridge or through the trust bridge to the first trader. Similarly, a digital signature of the second party can be received coupled to the confirmation communication as shown in block 1140. Alternatively, a copy of the communication transmitted to the second party via the trust bridge can be returned by the second party to the trust bridge signed by the digital signature of the second party. In addition, a delivery time stamp can be provided by the second trader to indicate the time the communication was received by the second trader as shown in block 1144. As noted earlier, block 1148 illustrates that a copy of the communication which travels via the trust bridge can be stored for confirming the transmission of the communication from a first or second trader. Finally, block 1152 shows that the digital signature of the first party coupled to a copy of the communication could also be stored. Any or all of these evidentiary methods exemplify methods that could be utilized to establish non-repudiation of a message used in transactions between the first and second traders.

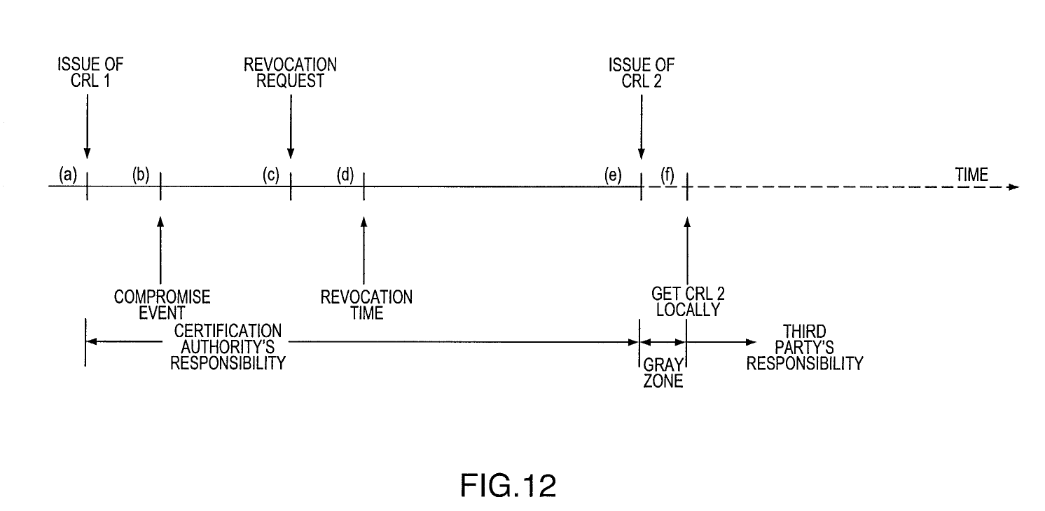

FIG. 12 illustrates an embodiment of the invention for accomplishing distributed liability for a transaction involving a trust bridge. Namely, FIG. 12 illustrates the distribution of responsibility for a certificate revocation. In FIG. 12, at period A, a certificate revocation list 1 is issued. At point B, a compromised event occurs which affects the validity of a certificate. Between points B and C on the graph, the compromised event has occurred, but the certificate authority has not yet been notified of the compromised certificate. At point C a revocation request is issued and the compromised event is notified to the certificate authority, but the certificate authority has not yet posted the revocation. A certificate user such as the trust bridge, cannot be expected to have knowledge of the compromise at this time. At period D the certificate is revoked. Then, at period E a second certificate revocation list is issued by the certificate authority. Between events B and E, the revocation has been posted but the new certificate revocation list has not yet been issued. Therefore, the user still does not know of the compromise. In this example, the certificate authority is responsible for receiving the revocation request and issuing a new certificate revocation list. Therefore, between events A and E the CA is responsible under its certification practice statement. A trust bridge can obtain the certificate revocation list and utilize it for validating certificates associated with business transactions exchanged between trading partners using different CAs. Therefore, it can define a period of time from when the second certificate revocation list is issued until it will assume responsibility for incorrect validation of a certificate. Namely, the trust bridge needs to be able to account for delays in receiving the new certificate revocation list issued by a certificate authority. For example, a delay could occur due to failure of the network to convey the new certificate revocation list to the trust bridge in a timely manner. Therefore, a gray zone, i.e., a period in which the old CRL does not reflect the current status of the compromised certificate, exists between the issuance of the certificate revocation list and receipt by the trust bridge. However, after a predefined period from when a new certificate revocation list is generated, the trust bridge can assume financial responsibility as outlined by its trust bridge practice statement for assuming responsibility for the incorrect validation of a certificate. Thus, this embodiment of the invention provides a method of distributing liability between a certificate authority and a trust bridge so as to facilitate a trusted communication between parties associated with different CAs.

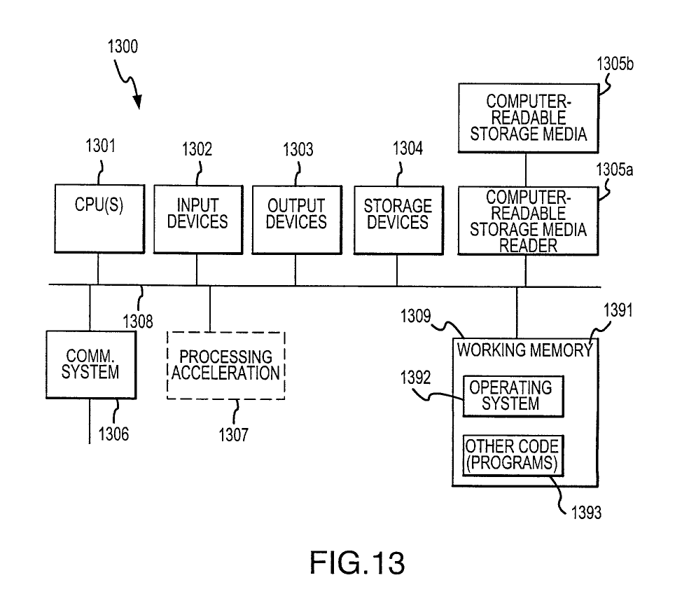

FIG. 13 illustrates one embodiment of a system, e.g., a server, which can be utilized to implement a trust bridge. System 1300 is shown comprised of hardware elements that are electrically coupled via bus 1308, including a processor 1301, input device 1302, output device 1303, storage device 1304, computer-readable storage media reader 1305a, communications system 1306 processing acceleration (e.g., DSP or special-purpose processors) 1307 and memory 1309. Computer-readable storage media reader 1305a is further coupled to computer-readable storage media 1305b, the combination comprehensively representing remote, local, fixed and/or removable storage devices plus storage media, memory, etc. for temporarily and/or more permanently containing computer-readable information, which can include storage device 1304, memory 1309 and/or any other such accessible system 1300 resource. System 1300 also comprises software elements (shown as being currently located within working memory 1391) including an operating system 1392 and other code 1393, such as programs, applets, data and the like.

System 1300 can provide extensive flexibility and configurability consistent with that already enabled. Thus, for example, a single architecture might be utilized to implement one or more servers that can be further configured in accordance with currently desirable protocols, protocol variations, extensions, etc. However, it will be apparent to those skilled in the art that substantial variations may well be utilized in accordance with more specific application requirements. For example, one or more system elements might be implemented as sub-elements within a system 1300 component (e.g. within communications system 1306). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) and certainly not all system 1300 components will be required in all cases.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

It is thought that the apparatuses and methods of the embodiments of the present invention and many of its attendant advantages will be understood from this specification and it will be apparent that various changes may be made in the form, construction, and arrangement of the parts thereof without departing from the spirit and scope of the invention or sacrificing all of its material advantages, the form herein before described being merely exemplary embodiments thereof.

What is claimed is:

1. A method of providing financial responsibility for a transaction between a first trader certified by a first certificate authority and a second trader certified by a second certificate authority, wherein said transaction is based on a communication for a product communicated between said first trader and said second trader and wherein said first trader and said second trader have no common certificate authority, said method comprising:
receiving at a trust bridge a certificate for said first trader issued by said first certificate authority;
receiving at said trust bridge a certificate for said second trader issued by said second certificate authority;
providing validation of said first trader to said second trader by said trust bridge;
providing financial responsibility for incorrect validation of said first trader to said second trader by said trust bridge.

2. The method as described in claim 1 and further comprising:
providing validation of said second trader to said first trader by said trust bridge.

3. The method as described in claim 2 and further comprising:
providing financial responsibility for incorrect validation of said second trader to said first trader by said trust bridge.

4. The method as described in claim 1 wherein said first certificate authority provides financial responsibility for incorrect validation of said first trader to said trust bridge.

5. The method as described in claim 4 wherein said second certificate authority provides financial responsibility for an incorrect validation of said second trader to said trust bridge.

6. The method as described in claim 1 wherein said second certificate authority provides financial responsibility for an incorrect validation of said second trader to said trust bridge.

7. The method as described in claim 1 and further comprising:
receiving at said trust bridge a certification revocation list for said first certificate authority; and
receiving at said trust bridge a certification revocation list for said second certification authority.

8. The method as described in claim 7 and further comprising:
compiling a master certification revocation list comprising said certificate revocation list for said first certificate authority and said certificate revocation list for said second certificate authority.

9. The method as described in claim 8 and further comprising:
publishing said master certificate revocation list to a participating hub.

10. The method as described in claim 1 and further comprising:
providing a certificate validation authority at said trust bridge.

11. The method as described in claim 10 and further comprising:
issuing a trust bridge practice statement so as to define liability limits of said trust bridge.

12. The method as described in claim 1 and further comprising:
obtaining a certificate revocation list for said first certificate authority;
obtaining a certificate revocation list for said second certificate authority;
creating a master certificate revocation list;
distributing a master certificate revocation list to a participating hub;
wherein said providing financial responsibility comprises providing financial responsibility for said distributed master certificate revocation list.

13. The method as described in claim 1 wherein said providing financial responsibility for incorrect validation of said first trader comprises basing said financial responsibility on the validity of a certificate of said first trader.

14. The method as described in claim 1 and further comprising:
providing a trust bridge practice statement for an entity which uses said trust bridge so as to define financial responsibility limits of said trust bridge.

15. The method as described in claim 14 wherein said first certificate authority provides a certification practice statement for an entity which uses said first certificate authority so as to define financial responsibility limits of said first certificate authority.

16. A method of establishing authentication between at least a first party and a second party, said method comprising:
certifying said first party with a first certificate authority;
certifying said second party with a second certificate authority different from said first certificate authority;
certifying a third party with said first certificate authority;
certifying said third party with said second certificate authority;
conveying a message from said first party to said third party such that said third party can authenticate said message from said first party;
conveying said message from said third party to said second party such that said second party can authenticate said message from said third party;
allowing said first certification authority to provide financial responsibility for an incorrect certification of said first party; and
providing financial responsibility by said third party to said second party for incorrect validation of a certificate issued by said first party.

17. The method as described in claim 16 and further comprising:
receiving at said third party a certificate revocation list for said first certification authority;
receiving at said third party a certificate revocation list for said second certification authority;
utilizing said certificate revocation list for said first certification authority and said certificate revocation list for said second certification authority to compile a master certificate revocation list.

18. The method as described in claim 16 and further comprising:
providing a trust bridge practice statement for an entity which uses said third party so as to define financial responsibility limits of said third party to said entity.

19. A method of providing non-repudiation of a communication from a first trader certified by a first certification authority to a second trader certified by a second certification authority, wherein said communication is for a product and wherein said first trader and said second trader have no common certification authority, said method comprising:
receiving certification of a trust bridge from said first certificate authority;
receiving certification of said trust bridge from said second certificate authority;
receiving at said trust bridge said communication from said first trader to said second trader via said trust bridge;
establishing non-repudiation of said communication from said first trader to said second trader with said trust bridge.

20. The method as described in claim 19 wherein said establishing non-repudiation of said communication comprises:
conveying said communication to said second party with a digital signature of said first trader and a digital signature of said trust bridge.

21. The method as described in claim 20 wherein said establishing non-repudiation of said communication comprises:
receiving at said trust bridge said communication with a digital signature of said second trader.

22. The method as described in claim 19 wherein said establishing non-repudiation of said communication comprises:
receiving at said trust bridge an origination time stamp coupled to said communication.

23. The method as described in claim 19 wherein said establishing non-repudiation of said communication comprises:
receiving at said trust bridge a delivery time stamp for said communication.

24. The method as described in claim 19 wherein said establishing non-repudiation of said communication comprises:
storing a copy of said communication at said trust bridge.

25. The method as described in claim 24 wherein said establishing non-repudiation of said communication comprises:
storing a digital signature of said first trader coupled to said copy of said communication.

26. A method of establishing a trust between at least a first party and a second party, said method comprising:
certifying said first party with a first certificate authority;
certifying said second party with a second certificate authority different from said first certificate authority;
certifying a third party with said first certificate authority;
certifying said third party with said second certificate authority;
conveying a message from said first party to said third party such that said third party can authenticate said message from said first party;
conveying said message from said third party to said second party such that said second party can authenticate said message from said third party;
utilizing said third party as a trust bridge to establish a trust relationship between said first party and said second party.

27. A method of establishing authentication between at least a first party and a second party, said method comprising:
certifying said first party with a first certificate authority;
certifying said second party with a second certificate authority different from said first certificate authority;
certifying a third party with said first certificate authority between said first party and said third party;
certifying said third party with said second certificate authority;
conveying a message from said first party to said third party, such that said third party can authenticate said message from said first party;
conveying said message from said third party to said second party, such that said second party can authenticate said message from said third party.

28. A computer readable medium having computer executable instructions for performing a method of establishing a trust between at least a first party and a second party, said method comprising:
receiving certification at a computer from a first certificate authority, wherein said first certificate authority also certifies said first party;
receiving certification at said computer by a second certificate authority, wherein said second certificate authority also certifies said second party;
receiving a message at said computer from said first party such that said message from said first party can be authenticated;
conveying said message to said second party from said computer such that said second party can authenticate said message;
utilizing said computer as a trust bridge between said first party and said second party so as to establish a trust relationship between said first party and said second party.
